(19) United States
(12) Patent Application Publication
(10) Pub. No.: US 2002/0118707 A1
(43) Pub. Date: Aug. 29, 2002

(54) Digital subscriber line arrangement

(76) Inventors: Jussi Autere, Hyvinkaa (FI); Sylvain Lusetti, Espoo (FI)

Correspondence Address: YOUNG & THOMPSON, 745 SOUTH 23RD STREET 2ND FLOOR, ARLINGTON, VA, 22202

(21) Appl. No.: 09/790,807

(22) Filed: Feb. 23, 2001

(51) Int. Cl. H04J 3/04

(52) U.S. Cl. 370/532

(57) ABSTRACT

This invention relates to digital subscriber line arrangements. The invention divides the functionality of an xDSL-DSLAM device into two separate parts: a subunit and upper unit. The subunit contains xDSL line cards for copper pair lines to downstream and a multiplexer for multiplexing the transmission channels of the pair lines to an upstream transmission line. The upper unit contains a CPU, which handles, for example, management and security tasks, a router for routing messages between the channels of a backbone (trunk) network and subscriber lines, and an internal bus for connecting the equipment of the upper unit.

### FIELD OF THE INVENTION

This invention relates to digital subscriber line arrangements and more particularly to the arrangements, which obtain to distribute broadband transmission lines to as multiple subscribers as possible.

### BACKGROUND OF THE INVENTION

Digital Subscriber Line (DSL) is a common term for various techniques, which make it possible to transmit digital traffic over ordinary telephone lines. Thus, a normally used abbreviation is xDSL wherein x can be replaced by a letter that identifies the technique in question. So the acronym xDSL refers collectively to a number of variations of the DSL technology, which aim at utilizing the information transmission capability of ordinary copper wires to the greatest possible extent. Known variations that go under the umbrella definition of xDSL are at the priority date of this patent application ADSL (Asymmetric Digital Subscriber Line), CDSL (Consumer DSL, registered trademark of Rockwell International Corp.), G.Lite (also known as DSL Lite, splitterless ADSL, and Universal ADSL; officially ITU-T standard G-992.2), HDSL (High bit-rate DSL), RADSL (Rate-Adaptive DSL), SDSL (Symmetric DSL), VDSL (Very high data rate DSL) and even to some extent UDSL (Unidirectional DSL), which is only a proposal, and IDSL (ISDN DSL), which is actually closer to ISDN (Integrated Services Digital Network).

The ultimate goal is to obtain broadband transmission connections to the last end, i.e. to the terminals of the customers. A tendency is to install fiber lines close to the buildings and subscribers (fiber to the neighborhood) as possible and in buildings under construction. But in existing infrastructure and buildings, the installation costs are remarkable, so existing copper pair lines with the xDSL technology are more economic to use.

However, there are some drawbacks in using the xDSL technology. The length of a copper pair line is limited since digital signals attenuate relatively fast in the copper pair line. A thumb rule is that the faster xDSL line is the shorter is the length of the line. An xDSL line may also run at the same frequency area as an amateur radio transmitter nearby, which interfers with the xDSL line. Other radiowave devices may also interference with the xDSL line. In addition, both the attenuation and interference cause bit errors.

Furthermore, xDSL devices, especially DSLAM (Digital Subscriber Line Access Multiplexer) devices, are relatively complicated and expensive. A so called “last mile” restriction is considered to be especially harmful. A situation may be that the distance between a central office (exhange) and customers' premise equipment is too long for using an adequate xDSL technique (FIG. 1), and there are difficulties in locating an xDSL-DSLAM somewhere in between the central office and the customer's premise (FIG. 2) due to the costs of the xDSL-DSLAM and environmental reasons.

The aim of this invention is to minimize these drawbacks. This is achieved in a way described in the claims.

### SUMMARY OF THE INVENTION

The idea of the invention is to divide the functionality of an xDSL-DSLAM device into two separate parts. Necessary transmission equipment form a subunit, which is an inexpensive and physically small part and relatively robust against environmental conditions. The subunit contains xDSL ports for copper pair lines to downstream and a multiplexer for multiplexing the transmission channels of the pair lines to an upstream transmission line. The other unit is an upper unit, which contains equipment that is expensive and delicate against environmental conditions. The upper unit contains a CPU, which handles, for example, management and security tasks, a router for routing messages between the channels of a backbone (trunk) network and subscriber lines, and an internal bus for connecting the equipment of the upper unit.

The arrangement makes it possible to provide broadband connections to customers, which are not reachable at present due to the last mile restriction. Due to the division, the subunit can be installed in a street cabinet without weather conditions needing to be thoroughly taken into account. The arrangement of the two units is also economical for operators.

### BRIEF DESCRIPTION OF THE DRAWINGS

In the following the invention is described in more detail by means of FIGS. 1-4 in the attached drawings where.

FIG. 1 illustrates an example of a present arrangement of xDSL lines,

FIG. 2 illustrates another example of a present arrangement of xDSL lines,

FIG. 3 illustrates an example of an xDSL arrangement according to the invention.

FIG. 4 illustrates the example of FIG. 3 in more detail.

### DETAILED DESCRIPTION OF THE PREFERRED EMBODIMENT

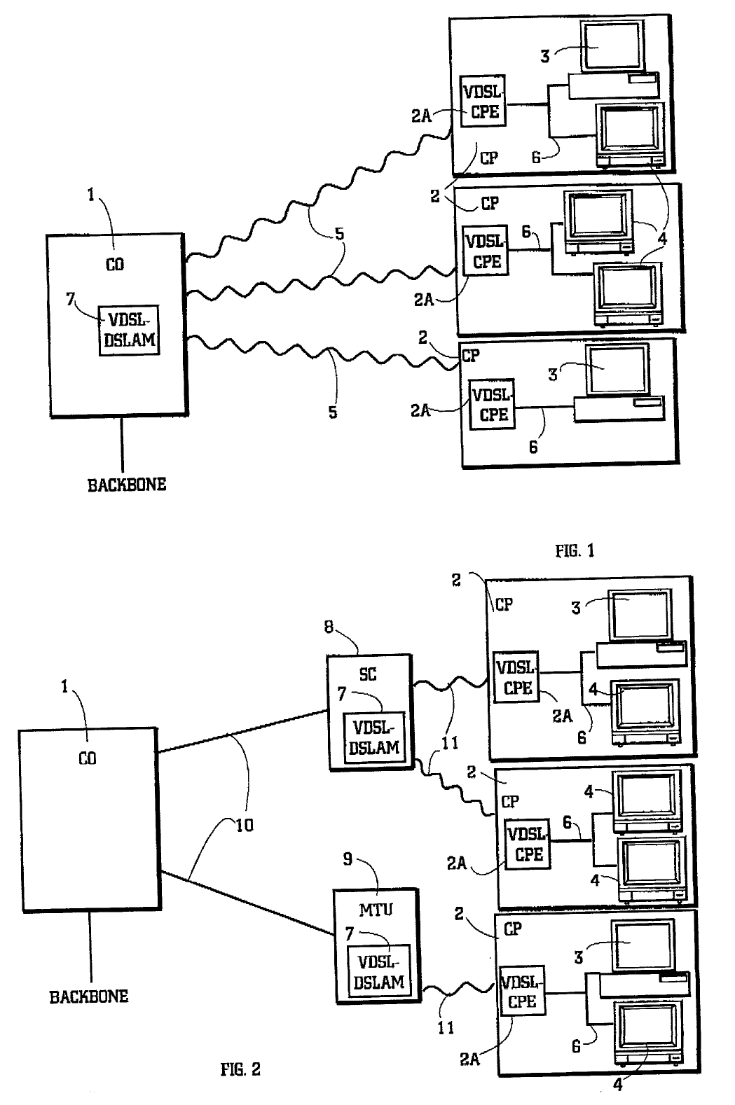

In this context examples are described to concern VDSL-DSLAM systems. However, it is clear that another xDSL-DSLAM system is possible to use alternatively. FIG. 1 shows an example of a present solution wherein a VDSL-DSLAM 7 is located in a central office (CO) 1 (exchange). Normal twisted copper pair wires 5 forms subscriber lines between the CO and customer premises (CP) 2 or alternatively directly between the CO and customers' terminals, which contain the VDSL modem. The CP contains a VDSL modem (or XDSL modem) or a VDSL router or bridge, which are called Customer Premises Equipment (CPE) 2A. The CPEs collect the channels of customers' terminals 3, 4 from the distribution area, such as LAN 6, of each CPE for the common upstream lines 5. The customers' terminals can be, for example, telephones, display terminals 4 or PCs 3. It is worth noting that the copper pair lines have been marked as wave lines.

In this solution it is safe to locate the VDSL-DSLAM in the CO wherein environmental (usually indoor) conditions are relatively permanent and safe. But the distance between the customers and the CO can be too long for the use of the VDSL (or other xDSL) system. By using another (simpIer) technique, for example, ADSL or SDSL, the required distance may be possible to obtain, but then lower transmission speeds must be accepted. Furthermore, it may be possible to try to customize the VDSL system, but it is always difficult and expensive. Many customers stay behind the last mile restriction.

FIG. 2 shows an example of a present solution, wherein the VDSL-DSLAM 7 is located in a street cabinet (SC) 8 or in a multi-tenant unit (MTU) 9, i.e. in a intermediate unit. In the figure the customers' lines 10 between the CO 1 and the SC and MTU are optical fibers, but this part of the network may also be constructed by using alternative technologies, for example wireless technologies. It is worth noting that the optical fibers have been marked as straight lines. Copper pair lines 11 to customers' premises starts from the CS and MTU.

In this solution the VDSL-DSLAM is located in the SC and/or MTU. The optical broadband connections are distributed quite near to customers. Thus, the lengths of the VDSL connections are relatively short. The short lengths are easier than the long lengths concerning the attenuation of the lines, interferences, and speed requirements. However, locating the VDSL-DSLAM in a street cabinet (or multi-tenant unit outdoor) is an uneconomic solution since the VDSL-DSLAM is expensive and the DSLAM-systems are subject to permanent support, repairing and updating. Furthermore, environmental conditions (outdoor) may be fatal for the delicate parts of the VDSL-DSLAM. Street cabinets may also be targets of vandalism. When locating the VDSL-DSLAM in the MTU 9 or even in the customers' premises 2, the optical fiber lines must be reachable in the building, which is usually not the case. And if this is possible, the number of the customer lines is relatively low, so this architectural solution is uneconomical.

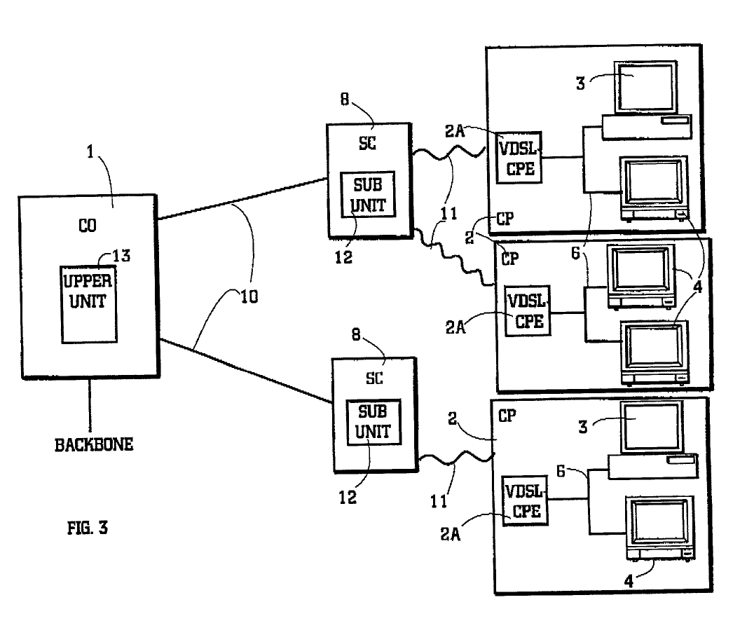

FIG. 3 shows an example of the arrangement according to the invention. The functionality of the VDSL-DSLAM 7 is divided into two parts: an upper unit 13 and a subunit 12. The subunit contains necessary equipment for transmitting VDSL traffic over the copper wires 11 for customers' premises. Preferably, the subunit is located in a street cabinet 8, but it can be located in another suitable place, i.e. in an intermediate unit, between the CO and customers' premises 2, or a hardened version even in open air. In some solutions it may be reasonable to locate the subunit even in the customer's premises. The upper unit contains the other functionalities of the VDSL-DSLAM unit, which are expensive and delicate against environmental conditions.

The transmission link is preferably an optical fiber 10 between the upper unit and subunit. The fiber carries, preferably as well, cost-efficient Ethernet bus traffic although other traffic types are possible. The Ethernet bus speed can be, for example, 1 Gbits/s in which case the bus supports even up to tens of kilometers length of the fiber link. If the fiber link is not possible to install, other transmission links can be used, such as a microwave link or multiple copper cables. It is worth noting that the flexibility of 1 Gbit/s Ethernet as the bus solution makes this possible.

As can be noticed, the solution according to the invention offers broadband connections to more subscribers than the present solutions since it brings an effective xDSL, such as VDSL, technique near to them. The solution according to the invention is also more economical than the present solutions. This is achieved because the expensive upper unit can handle several subunits, so the investment cost per subscriber line is lower than in the case of the VDSL-DSLAM being located in a street cabinet. In addition, high transmission rates are easier to achieve more reliably than before, due to robustness against environmental conditions.

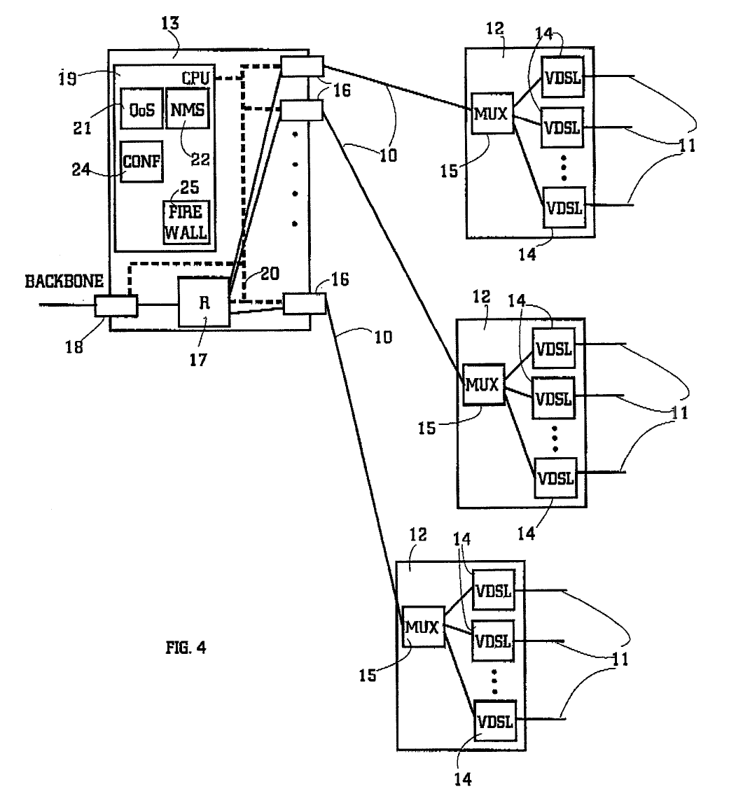

FIG. 4 shows the example of FIG. 3 in more detail. The subunit 12 contains at least one VDSL (or another type of XDSL) modem 14 (modem is preferably in a line card, which can contain more than one modem and port) and a multiplexer 15 for multiplexing the channels of the subscriber for the upstream (optical fiber) link 10.

The upper unit 13 contains at least one interface 16 for the optical fiber link between the upper unit and subunit, a router 17 for routing messages between the backbone channels and the downstream channels, at least one interface 18 for the backbone link, a CPU 19, and an internal bus 20 for connecting all elements of the upper unit. The internal bus has been marked in dashed line. The CPU handles different tasks concerning the subscriber lines and channels, such as management, quality, and security tasks. The QoS (Quality of Service) block 21 follows that required transmission quality levels are satisfied. The NMS (Network Management System) block 22 handles different management tasks. The CONF block 24 handles configurations of the subunits and the firewall block 25 handles security tasks. It should be noticed that the CPU may contain other blocks too. The upper unit may as well contain other elements than mentioned above.

As can be noticed in the light of the examples described above, the invention provides broadband connections to more customers than the present solution. The invention also offers an economic and reliable solution for a variety of different construction environments. So, it is evident that the invention is not restricted to the examples above, but it can be used in other solutions as well, in the scope of the inventive idea.

What is claimed is:

1. An arrangement of a digital subscriber line access multiplexer, comprising a CPU, a multiplexer, at least one digital subscriber line card, a router, and a data bus, the arrangement divided into two parts, the first part including the CPU, the router, and the data bus, and the second part including at least one digital subscriber line card and the multiplexer, a transmission link connecting the first part and the second part.

2. An arrangement according to claim 1, comprising several second parts, the second part specific transmission links connecting the first part and the second part.

3. An arrangement according to claim 1, wherein the first part is located in a central office and the second part between the central office and customer premises.

4. An arrangement according to claim 1, wherein the first part is located in a central office and the second part is located in a customer premises.

5. An arrangement according to claim 3, wherein the second part is located in a street cabinet.

6. An arrangement according to claim 3, wherein the second part is located in a multi-tenant unit.

7. An arrangement according to claim 5, wherein the transmission link between the central office and the street cabinet is an optical fiber.

8. An arrangement according to claim 5, wherein the transmission link between the central office and the street cabinet is multiple copper wires.

9. An arrangement according to claim 5, wherein the transmission link between the central office and the street cabinet is a radio link.

10. An arrangement according to claim 6, wherein the transmission link between the central office and the multi-tenant unit is an optical fiber.

11. An arrangement according to claim 6, wherein the transmission link between the central office and the multi-tenant unit is a radio link.

12. An arrangement according to claim 6, wherein the transmission link between the central office and the multi-tenant unit is multiple copper wires.

13. An arrangement according to claim 4, wherein the transmission link between the central office and the customer premises is an optical fiber.

14. An arrangement according to claim 4, wherein the transmission link between the central office and the customer premises is multiple copper wires.

15. An arrangement according to claim 4, wherein the transmission link between the central office and the customer premises is a radio link.

16. An arrangement according to claim 4, wherein the transmission link between the central office and the customer premises forms an Ethernet bus.

17. An arrangement according to claim 5, wherein the transmission link between the central office and the street cabinet forms an Ethernet bus.

18. An arrangement according to claim 6, wherein the transmission link between the central office and the multi-tenant unit forms an Ethernet bus.

19. An arrangement according to claim 1 wherein the first part further comprises at least one interface for downstream transmission links and at least one interface for upstream transmission links.

20. An arrangement according to claim 1, wherein the digital subscriber line card is a VDSL line card.

21. An arrangement according to claim 1, wherein the digital subscriber line card is any xDSL line card.
